(19) United States
(12) Patent Application Publication
(10) Pub. No.: US 2010/0137040 A1
(43) Pub. Date: Jun. 3, 2010

(54) MOBILE TERMINAL APPARATUS

(75) Inventor: Yoshihiko Kaito, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/609,881

(22) Filed: Oct. 30, 2009

(30) Foreign Application Priority Data
Nov. 28, 2008 (JP) 2008-305599

(51) Int. Cl. H04M 1/00

(52) U.S. Cl. 455/575.3

(57) ABSTRACT

A mobile terminal apparatus including a movable housing and a stationary housing which are connected in a foldable manner by a hinge connecting member includes a movable rear casing disposed in the movable housing. The movable rear casing includes a front panel and an upper plate member and the upper plate member is secured to the front panel. Further, the mobile terminal includes a plate member disposed within the movable rear casing. The plate member includes a main plate portion and a protruding plate portion. The protruding plate portion protruded from a part of the main plate portion, wherein the protruding plate portion continues to a peripheral portion of the hinge connecting member and is disposed in the upper plate member.

### CROSS-REFERENCE TO RELATED APPLICATIONS

This application is based upon and claims the benefit of priority of the prior Japanese Patent Application No. 2008-305599, filed on Nov. 28, 2008, the entire contents of which are incorporated herein by reference.

### FIELD

The embodiments discussed herein are related to a mobile terminal apparatus including a stationary housing and a movable housing which are connected to each other by a hinge connecting member.

### BACKGROUND

Mobile phones smaller in size and thinner in thickness are recently demanded. To comply with this demand, the mobile phones have a tendency to adopt a two-housing structure in which a stationary (fixed) and a movable housings are connected to each other by a hinge connecting member. The two housings of such a mobile phone are capable of pivoting around the hinge connecting member and of a foldable type and made of a resin material or the like. It is preferable for the two housings to have durability to withstand impact or load applied dropping the mobile phone or opening and closing the movable housing from and to the stationary housing.

Overall Structure of Conventional Mobile Phone

The schematic structure of a mobile phone 100 as a conventional mobile phone will be described with reference to FIGS. 13 and 14. FIG. 13 is a perspective view illustrating the overall structure of the mobile phone 100. FIG. 14 is an enlarged sectional view of a part of the mobile phone 100 illustrated in FIG. 13.

As depicted in FIG. 13, the mobile phone 100 includes a stationary housing 10 and a movable housing 20. The stationary housing 10 and the movable housing 20 are pivotable around a hinge connecting member 13. A normal open position or operation position of the movable housing 20 is shown by the solid lines in FIG. 13. If the mobile phone 100 is dropped or the movable housing 20 is excessively pivoted away from the stationary housing 10, there is a risk that the movable housing 20 will be excessively deformed or a large stress will be applied to the hinge connecting member 13. The direction in which the movable housing 20 is excessively pivoted is, for example, the direction illustrated by the arrow in FIGS. 13 and 14.

More specifically, when the mobile phone 100 is opened, an end portion of an upper plate member 34 of a front panel 31 included in the movable housing 20 comes into contact with a contact portion 12a formed in an upper section of a stationary rear casing 12 included in the stationary housing 10. As a result, the movable housing 20 is stopped at an angle illustrated in FIG. 14.

If the mobile phone 100 is excessively opened in an opening direction thereof, the movable housing 20 is pivoted beyond a pivotable area thereof. Therefore, a large stress will be applied to a movable rear casing 30 and the hinge connecting member 13.

As a result, there is a risk that a crack will be formed at a base P, of which portion is illustrated by ellipse, of the hinge connecting member 13 or the hinge connecting member 13 itself will break due to a concentration of the large stress applied to the hinge connecting member 13.

For reinforcing a hinge member, Japanese Laid-open Patent Publication No. 2003-258446 discloses a reinforcing member made of metal is insert-molded in a bearing casing of a hinge portion in a mobile phone of the above-described type. The hinge portion increases the hinge mechanism which connects also a movable housing and a stationary housing to each other. In this mobile phone, a cylindrical reinforcing member is disposed in the hinge portion of the hinge mechanism to increase the strength of the hinge portion.

In the above-described mobile phone, the strength of the hinge portion is increased by insert-molding the reinforcing member. However, in the above-described mobile phone, the reinforcing member extends over the entire circumference of the hinge portion. Therefore, the reinforcing member increases the weight and results in difficulty of reducing the weight of the mobile phone. In addition, a cumbersome manufacturing process may be necessary for forming integrally the cylindrical reinforcing member and the hinge portion made of resin material.

In addition, in the above-described mobile phone, some electrical components are disposed around the hinge portion and in areas surrounding the hinge portion because the electrical components, for example, are such as an antenna for wireless communication and a flexible cable for supplying electricity between the stationary housing and the movable housing. Since the flexible cable and the antenna are disposed near the metal in the reinforcing member, a problem occurs that their characteristics may be degraded.

### SUMMARY

According to an aspect of the invention, a mobile terminal apparatus including a movable housing and a stationary housing which are connected in a foldable manner by a hinge connecting member includes a movable rear casing disposed in the movable housing. The movable rear casing includes a front panel and an upper plate member and the upper plate member is secured to the front panel. Further, the mobile terminal includes a plate member disposed within the movable rear casing. The plate member includes a main plate portion and a protruding plate portion. The protruding plate portion protruded from a part of the main plate portion, wherein the protruding plate portion continues to a peripheral portion of the hinge connecting member and is disposed in the upper plate member.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a plan view of a mobile phone according to a first embodiment in an opened state;

FIG. 2 is a perspective view illustrating the external appearance of the mobile phone;

FIG. 3 is a top view illustrating the external appearance of the mobile phone;

FIG. 4 is a side view illustrating the mobile phone in an opened state;

FIG. 5 is a side view illustrating the mobile phone in a closed state;

FIG. 6 is a view of the mobile phone shown in FIG. 5 on arrow VI;

FIG. 7 is a view of the mobile phone shown in FIG. 5 on arrow VII;

FIG. 8 is an enlarged sectional view of the mobile phone shown in FIG. 3 taken along line VIII-VIII;

FIG. 9 is a view of the mobile phone shown in FIG. 8 on arrow IX;

FIG. 10 is an external perspective view illustrating a reinforcing plate member;

FIG. 11 is an enlarged sectional view of a portion of the mobile phone;

FIG. 12A is an enlarged perspective view of a protruding plate portion of a reinforcing plate member according to a second embodiment;

FIG. 12B is an enlarged perspective view of a protruding plate portion of a reinforcing plate member according to a third embodiment;

FIG. 12C is an enlarged perspective view of a protruding plate portion of a reinforcing plate member according to a fourth embodiment;

FIG. 13 is a perspective view illustrating the external appearance of a mobile phone according to a related art; and

FIG. 14 is an enlarged sectional view of a part of the mobile phone shown in FIG. 13.

### DESCRIPTION OF EMBODIMENTS

Preferred embodiments of the mobile terminal apparatus disclosed herein will now be described in detail with reference to the accompanying drawings. In the following embodiments, a mobile phone is described as an example of a mobile terminal apparatus. The present invention is not limited to the embodiments described below.

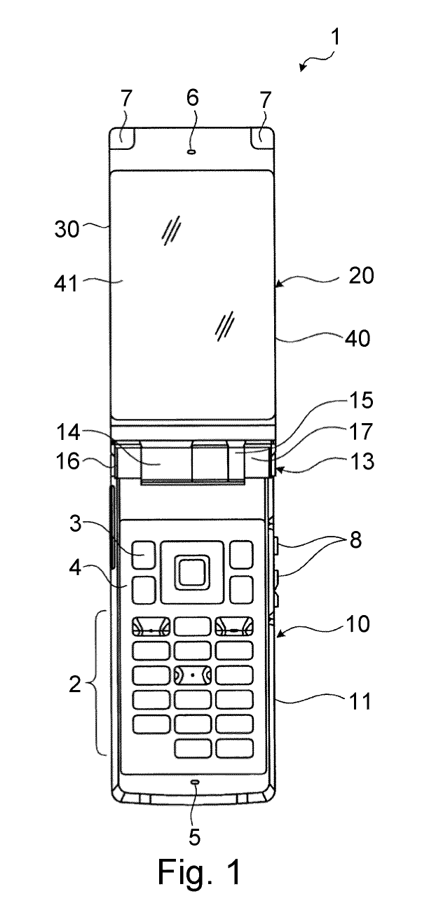

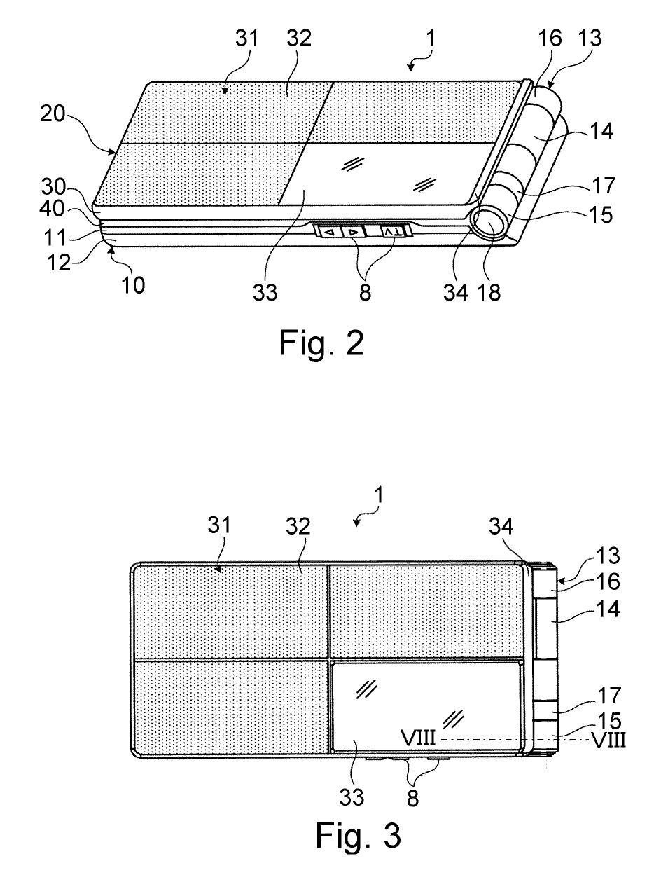

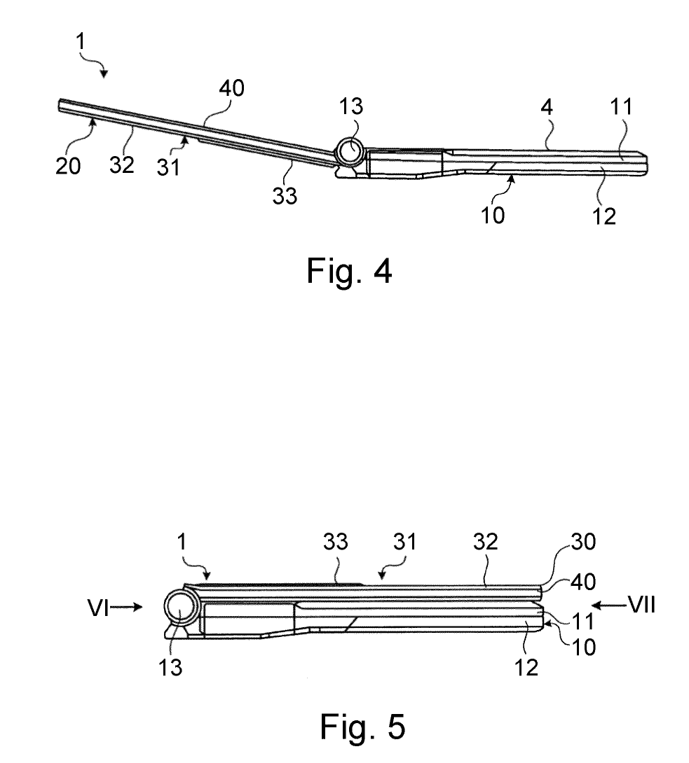

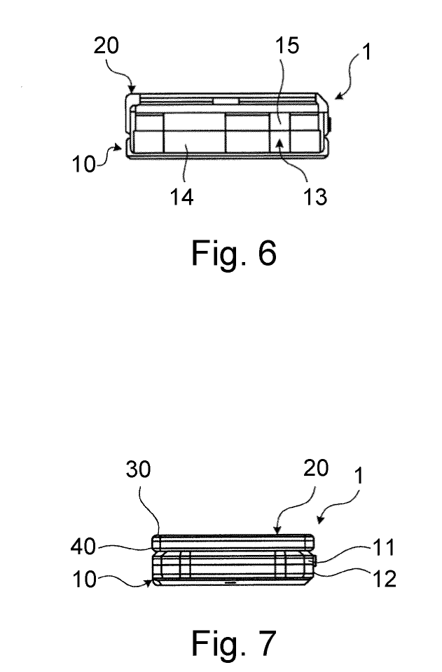

FIG. 1 is a plan view of a mobile phone 1 according to a first embodiment in an opened state. FIG. 2 is a perspective view illustrating the external appearance of the mobile phone 1. FIG. 3 is a top view illustrating the external appearance of the mobile phone. FIGS. 4 and 5 are side views of the mobile phone 1 in the opened state for operation and the closed state, respectively. FIG. 6 is a view of the mobile phone 1 shown in FIG. 5 on arrow VI, and FIG. 7 is a view of the mobile phone 1 illustrated in FIG. 5 on arrow VII.

As shown in FIGS. 1 to 7, the mobile phone 1 includes a stationary housing 10 and a movable housing 20 in the size of a palm. The stationary housing 10 and the movable housing 20 are connected to each other by a hinge connecting member 13 in a pivotable manner.

More specifically, as illustrated in FIG. 1, the stationary housing 10 included in the mobile phone 1 is used for transmission, and is provided with various operation keys including key switches 2, such as numeric keys, and function keys 3. The movable housing 20 included in the mobile phone 1 has substantially the same size of planar view depicted in FIG. 1 as that of the size of the stationary housing 10, and is provided with an LCD module (not shown). The hinge connecting member 13 connects the stationary housing 10 and the movable housing 20 to each other in a pivotable manner. The stationary housing 10 and the movable housing 20 have a thin box shape, and are made of, for example, a magnesium alloy which is light and strong.

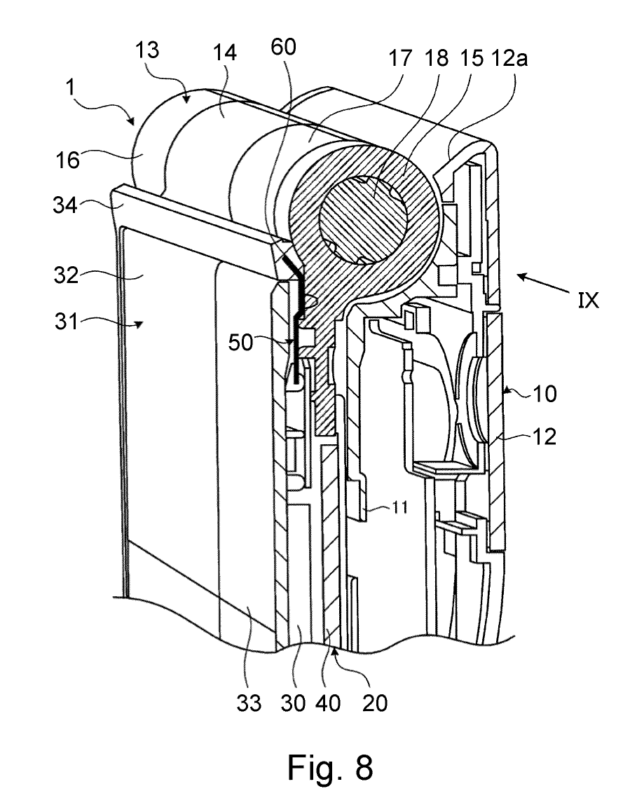

As shown in FIG. 8, the hinge connecting member 13 is formed by assembling substantially cylindrical hinge parts 14 and 15 formed at an end of a movable rear casing 30 and substantially cylindrical hinge parts 16 and 17 formed at an end of a stationary front casing 11.

The hinge parts 14 and 15 provided at the end of the movable rear casing 30 are assembled to a cylindrical member 18 including the hinge parts 16 and 17 provided at the end of the stationary front casing 11. Therefore, the hinge parts 14 and 15 are rotatable with respect to the cylindrical member 18. Thus, the hinge connecting member 13 allows the movable housing 20 including the movable rear casing 30 to pivot with respect to the stationary housing 10 in a predetermined direction.

With regard to the widths of the hinge parts 14 and 15 on the movable rear casing 30, the width of the hinge part 14 is larger than the width of the hinge part 15 so that an electrical wiring cable for supplying electricity may be disposed in the hinge part 14.

The stationary housing 10 has a two-block structure of the stationary front casing 11 and a stationary rear casing 12 (see FIG. 2). The stationary front casing 11 includes an operation panel 4 in which various operation keys, such as the key switches 2, are arranged (see FIG. 1). The stationary front casing 11 is disposed at the inner side of the mobile phone 1 and the stationary rear casing 12 is disposed at the outer side of the mobile phone 1.

As illustrated in FIG. 1, the stationary front casing 11 is provided with the operation panel 4 having the above-described key switches 2 and the function keys 3 and a mouthpiece 5 in which a microphone for converting the voice of a user into an electric signal is disposed.

Side keys 8 including a pair of volume keys used for adjusting the volume of a radio or the like and a TV key are provided on a side plate portion of the stationary rear casing 12. The stationary front casing 11 and the stationary rear casing 12 are assembled to each other with screws (not shown) at four positions.

As illustrated in FIGS. 2 and 5, the movable housing 20 has a two-block structure including the movable rear casing 30 disposed at the outer side of the mobile phone 1 and a movable front casing 40 disposed at the inner side of the mobile phone 1.

A metal frame plate (not shown) is disposed in the movable rear casing 30. As illustrated in FIGS. 2 and 3, a front panel 31 is composed of a metal panel element 32 made of metal and a transparent panel 33 made of a transparent material. The metal panel element 32 and the transparent panel 33 are adhered to a top surface of the metal frame plate with a double-sided adhesive member (not shown) at predetermined positions.

An upper plate member 34 is fixed to the front panel 31 at an end closer to the hinge connecting member 13. The upper plate member 34 slightly projects toward the outside of the mobile phone 1 (see FIGS. 3 and 8). A time display unit (not shown) for displaying information including the time is provided in an area in which the transparent panel 33 is disposed. Therefore, the user of the mobile phone 1 may visually check the information including the time on the transparent panel 33.

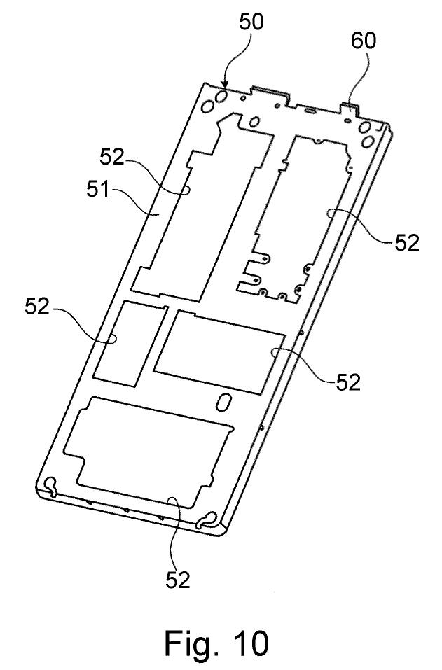

In addition, as shown in FIG. 8, a reinforcing plate member 50 for increasing the strength of the entire body of the movable rear casing 30 is disposed in the movable rear casing 30. The reinforcing plate member 50, as shown in FIG. 10, is part of a main plate portion 51 which also includes a protruding plate portion 60 protruding from the main plate portion 51. As shown in FIG. 10, the reinforcing plate member 50 and the protruding plate portion 60 provided in the movable rear casing 30 are characteristic parts of the present invention, and they will be described in detail below.

As illustrated in FIG. a, a large display panel 41 which displays the LCD module (not shown) is disposed on the surface of the movable front casing 40 at a substantially central area thereof. An earpiece 6 on which the user of the mobile phone 1 places the ear to hear the sound emitted therefrom is formed at an end of the display panel 41.

The casings 30 and 40 are also assembled to each other with screws (not shown) at four positions. In addition, covers 7, illustrated in FIG. 1, for hiding the screws are provided at the top of the display panel 41.

[Reinforcing Structure of Movable Rear Casing 30 and Hinge Connecting Member 13]

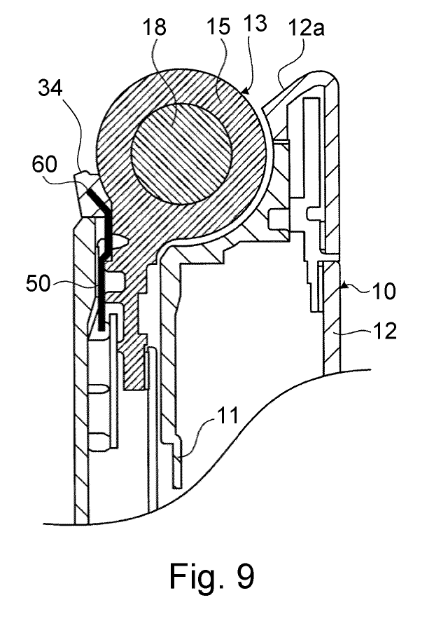

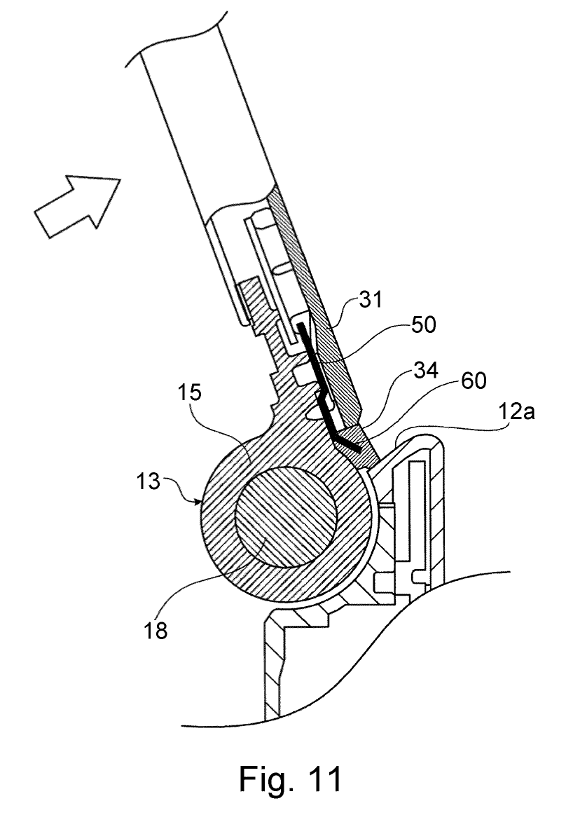

The reinforcing structure of the movable rear casing 30 and the hinge connecting member 13 will be described with reference to FIGS. 8 to 11. FIG. 8 is an enlarged perspective sectional view mobile phone 1 shown in FIG. 3 taken along line VIII-VIII. FIG. 9 is a sectional view of the mobile phone 1 shown in FIG. 8 on arrow IX. FIG. 10 is an external perspective view illustrating the reinforcing plate member 50. FIG. 11 is an enlarged sectional view of a portion of the mobile phone 1.

In the mobile phone 1 according to the present embodiment, the strength of the entire body of the movable rear casing 30 is increased by the reinforcing plate member 50. The reinforcing plate member 50 is a plate member made of metal and disposed in the movable rear casing 30 of the movable housing 20. The reinforcing plate member 50 is provided with the protruding plate portion 60, and the protruding plate portion 60 is disposed so as to surround a part of a peripheral portion of the hinge connecting member 13. Therefore, in the mobile phone 1 according to the present embodiment, the deformation of the movable rear casing 30 and the breakage of the hinge connecting member 13 may be prevented when the mobile phone 1 is excessively opened.

The upper plate member 34 of the front panel 31 has a structure including the protruding plate portion 60 made of a metal plate member having high rigidity. Accordingly, the excessive deformation of the movable rear casing 30 may be prevented when the upper plate member 34 comes into contact with the contact portion 12a.

As shown in FIGS. 8 to 11, the reinforcing plate member 50 for increasing the strength of the movable rear casing 30 is disposed in the movable rear casing 30. In addition, as illustrated in FIG. 10, a plurality of openings 52 are formed in the main plate portion 51 of the reinforcing plate member 50 at predetermined positions so that electrical components or the like disposed in the movable rear casing 30 are placed in the openings 52.

Information display units, such as the time display unit (not shown), are placed in some of the openings 52. The openings 52 also include a fitting hole to which the transparent panel 33 is fitted.

In addition, as illustrated in FIG. 10, the reinforcing plate member 50 includes the main plate portion 51 and the protruding plate portion 60 which protrudes from the main plate portion 51. The protruding plate portion 60 continues to the peripheral portion of the hinge connecting member 13 and is disposed in the upper plate member 34 fixed to the front panel 31 of the movable rear casing 30.

The reinforcing plate member 50 is composed of a metal frame which has the approximately same rectangular as the shape of the movable rear casing 30. Further, the metal frame has a slightly smaller width than the width of the movable rear casing 30. The main plate portion 51 of the reinforcing plate member 50 is provided with the protruding plate portion 60 which protrudes from the main plate portion 51 at an end of the main plate portion 51 closer to the hinge connecting member 13.

More specifically, the protruding plate portion 60 continues to the peripheral portion of the hinge connecting member 13 and is disposed in the upper plate member 34 fixed to the front panel 31 of the movable rear casing 30.

The protruding plate portion 60 is disposed near the hinge part 15, which is lower strength than the hinge part 14 because the width of the hinge part 15 is smaller than that of the hinge part 14. Thus, according to the present embodiment, one of the hinge parts 14 and 15 which has a smaller width and which therefore has a lower strength, that is, the hinge part 15, is reinforced by the protruding plate portion 60. As a result, the breakage in the hinge connecting member 13 is prevented.

In addition, the protruding plate portion 60 extends along only a part of the peripheral portion of the hinge part 15, more particularly, only to a predetermined position in the upper plate member 34. Therefore, the amount of increase in the weight of the mobile phone 1 may be reduced. In addition, the protruding plate portion 60 extends along only a part of the peripheral portion of the hinge part 15, while the conventional mobile phone 100 has a reinforcing member provided along the entire circumference of the hinge connecting member 13. Therefore, degradation of the characteristics of components disposed near the hinge part 15 may be prevented. More specifically, degradation of electrical characteristics of electrical components such as a flexible cable may be prevented, and degradation of antenna characteristics and reduction of antenna sensitivity of communication components such as an antenna may be prevented also. In the present embodiment, the protruding plate portion 60 has a linear shape in a side view, as illustrated in FIG. 10. However, the protruding plate portion 60 may also be partially bent.

As illustrated in FIG. 11, when the movable housing 20 is intended to be drawn away from the stationary housing 10 pivotally around the hinge 15 by more than a predetermined angle, the upper plate member 34 serves as a stopper for preventing the movable rear casing 30 of the movable housing 20 from pivoting by an excessive amount.

Since the protruding plate portion 60 made of metal which protrudes from a portion of the reinforcing plate member 50 is disposed in the upper plate member 34 of the front panel 31, the strength of the upper plate member 34 is increased. Therefore, when the mobile phone 1 is opened or closed, the hinge part 15 in the hinge connecting member 13 may be prevented from cracking or breaking due to the stress generated in the hinge part 15.

As described above, in the mobile phone 1 according to the present embodiment, the reinforcing plate member 50 which increases the rigidity of the movable rear casing 30 is provided in the movable rear casing 30. The reinforcing plate member 50 includes the main plate portion 51 and the protruding plate portion 60 which protrudes from the main plate portion 51. The protruding plate portion 60 continues to the peripheral portion of the hinge connecting member 13 and is disposed in the upper plate member 34 of the front panel 31 included in the movable rear casing 30. Therefore, in the mobile phone 1 according to the present embodiment, the strength of the hinge parts 14 and 15 may be ensured and the hinge part 15 may be prevented from breaking due to the stress generated in the hinge connecting member 13 when the mobile phone 1 is opened or closed.

The protruding plate portion 60 provided at the end of the reinforcing plate member 50 extends along only a part of the peripheral portion of the hinge part 15 included in the hinge connecting member 13. Therefore, the amount of increase in the weight of the reinforcing plate member 50 may be reduced. In addition, although the flexible cable and the antenna are disposed near the hinge connecting member 13 and the hinge part 15 in the movable rear casing 30, degradation of the electrical characteristics of the flexible cable and the antenna characteristics of the antenna may be prevented.

### Second Embodiment

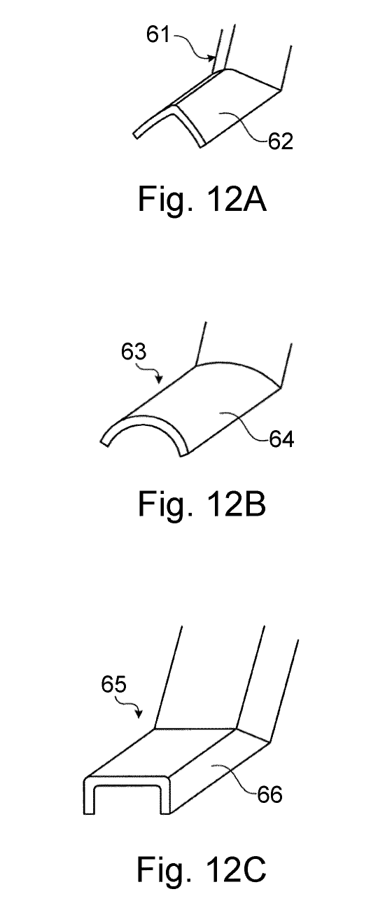

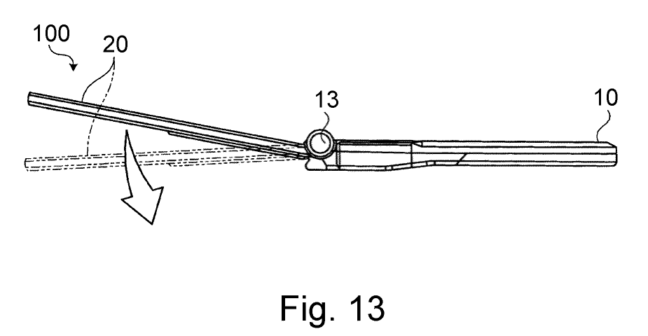

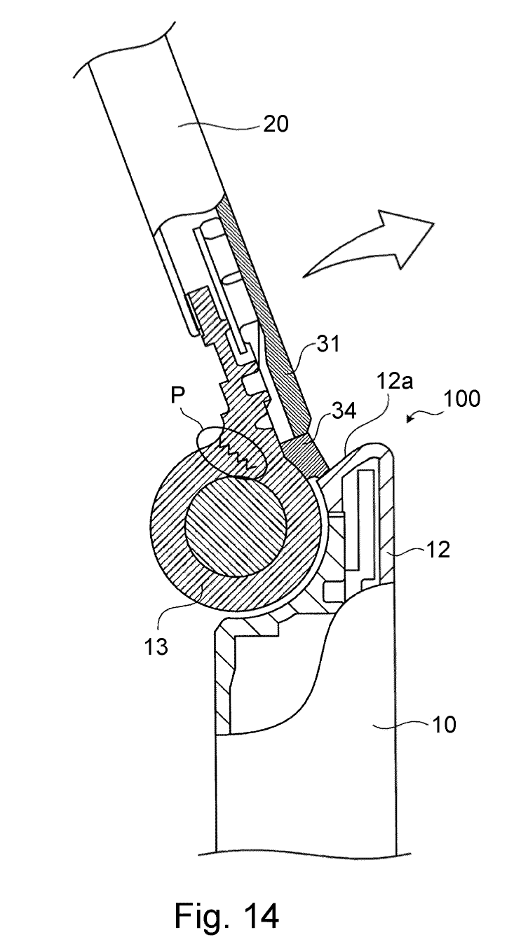

A protruding plate portion provided in a reinforcing plate member of a mobile phone according to a second embodiment will now be described. FIG. 12A is an enlarged perspective view of the protruding plate portion of the reinforcing plate member according to the second embodiment.

As illustrated in FIG. 12A, according to the second embodiment, a protruding plate portion 61 fixed at an end of the reinforcing plate member 50 is composed of a plate member 62 having an approximately triangular shape in cross section. Therefore, the geometrical moment of inertia corresponding to the bending stress applied to the plate member 62 may be increased. As a result, the rigidity of the movable rear casing 30 against the excessive force applied when the mobile phone 1 is opened or closed may be increased.

As described above, in the protruding plate portion 61 fixed at the end of the reinforcing plate member 50 according to the second embodiment, the plate member 62 which forms the protruding plate portion 61 is formed in an approximately triangular shape in cross section. Therefore, the geometrical moment of inertia corresponding to the bending stress applied to the plate member 62 may be increased. As a result, the rigidity of the movable rear casing 30 against the excessive force applied when the mobile phone 1 is opened or closed may be increased.

### Third Embodiment

A protruding plate portion provided in a reinforcing plate member of a mobile phone according to a third embodiment will now be described. FIG. 12B is an enlarged perspective view of the protruding plate portion of the reinforcing plate member according to the third embodiment.

As illustrated in FIG. 12B, according to the third embodiment, a protruding plate portion 63 fixed at an end of the reinforcing plate member 50 depicted in FIG. 10 is composed of a plate member 64 having an approximately arc shape in cross section. Thus, the plate member 64 which forms the protruding plate portion 63 is formed in an approximately arc shape in cross section. Therefore, the geometrical moment of inertia corresponding to the bending stress applied to the plate member 64 may be increased. As a result, the rigidity of the movable rear casing 30 against the excessive force applied when the mobile phone 1 is opened or closed may be increased.

As described above, in the protruding plate portion 63 fixed at the end of the reinforcing plate member 50 according to the third embodiment, the plate member 64 which forms the protruding plate portion 63 is formed in an approximately arc shape in cross section. Therefore, similar to the second embodiment, the geometrical moment of inertia corresponding to the bending stress applied to the plate member 64 of the protruding plate portion 63 may be increased. As a result, the rigidity of the movable rear casing 30 against the excessive force applied when the mobile phone 1 is opened or closed may be increased.

### Fourth Embodiment

A protruding plate portion provided in a reinforcing plate member of a mobile phone according to a fourth embodiment will now be described. FIG. 12C is an enlarged perspective view of the protruding plate portion of the reinforcing plate member according to the fourth embodiment.

As shown in FIG. 12C, according to the fourth embodiment, a protruding plate portion 65 fixed at an end of the reinforcing plate member 50 is composed of a plate member 66 having an approximately rectangular shape in cross section. Thus, the plate member 66 which forms the protruding plate portion 65 is formed in an approximately rectangular shape in cross section. Therefore, the geometrical moment of inertia corresponding to the bending stress applied to the plate member 66 may be increased. As a result, the rigidity of the movable rear casing 30 against the excessive force applied when the mobile phone 1 is opened or closed may be increased.

As described above, in the protruding plate portion 65 fixed at the end of the reinforcing plate member 50 according to the fourth embodiment, the plate member 66 which forms the protruding plate portion 65 is formed in an approximately rectangular shape in cross section. Therefore, similar to the second and third embodiments, the geometrical moment of inertia corresponding to the bending stress applied to the plate member 66 may be increased. As a result, the rigidity of the movable rear casing 30 against the excessive force applied when the mobile phone 1 is opened or closed may be increased.

### Other Embodiments

Although first to fourth embodiments have been described, the mobile terminal apparatus according to the technique disclosed herein is not limited to the first to fourth embodiments, and the disclosed technique may be applied in various other embodiments within the technical scope described in the appended claims.

For example, in the above-described first to fourth embodiments, the reinforcing plate member 50 is disposed in the movable rear casing 30. The protruding plate portion 60 to 63 which protrudes at en end of the reinforcing plate member 50 is provided in the upper plate member 34 fixed to an upper portion of the front panel 31 included in the movable rear casing 30.

In other words, in the first to fourth embodiments, the upper plate member 34 functions as a stopper when the excessive force is applied to open or close the mobile phone 1. The strength of the upper plate member 34 is increased so that the hinge connecting member 13 and the hinge part 15 are prevented from breaking due to the stress applied when the mobile phone 1 is opened or closed. However, it is not necessary that the reinforcing plate member 50 be provided as a separate member that is disposed in the movable rear casing 30 as in the first to fourth embodiments. Instead, a piece of plate made of metal which increases the strength of the upper plate member 34 may be disposed in the upper plate member 34 of the front panel 31 as an individual reinforcing piece. In such a case, the reinforcing piece continues to the peripheral portion of the hinge connecting member 13.

According to this embodiment, similar to the first to fourth embodiments, the strength of the upper plate member 34 is increased by the reinforcing piece made of metal. Therefore, the hinge connecting member 13 may be prevented from breaking when the excessive force is applied to open or close the mobile phone 1. In addition, the reinforcing plate member 50 made of metal disposed in the movable rear casing 30 in the first to fourth embodiments may be omitted. Therefore, the weight of the mobile phone may be reduced.

Similarly, instead of using the reinforcing plate member disposed in the movable rear casing 30 as a separate member, the reinforcing piece made of metal may be disposed in the hinge part 15 of the hinge connecting member 13. In this case, the strength of the hinge part 15 of the hinge connecting member 13 itself is increased by the reinforcing piece made of metal, and therefore the hinge connecting member 13 and the hinge part 15 may be prevented from breaking when the excessive force is applied to open or close the mobile phone 1.

Also in this embodiment, the reinforcing plate member 50 made of metal disposed in the movable rear casing 30 in the first to fourth embodiments may be omitted, and therefore the weight of the mobile phone may be reduced.

In the above-described first to fourth embodiments, a foldable mobile phone including hinge parts is explained as an example of a mobile terminal apparatus. However, the above-described technique may also be applied to various types of hinge structures other than the hinge structure illustrated in the figures. In addition, above-described technique may also be applied to various types of mobile terminal apparatuses including small information processing terminals, such as a personal digital assistant (PDA), small music playback apparatuses, mobile television devices, mobile game devices, etc., which have a foldable structure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A mobile terminal apparatus including a movable housing and a stationary housing which are connected in a foldable manner by a hinge connecting member comprising:
a movable rear casing disposed in the movable housing, the movable rear casing including a front panel and an upper plate member, the upper plate member secured to the front panel; and
a plate member disposed within the movable rear casing and including a main plate portion and a protruding plate portion, the protruding plate portion protruded from a part of the main plate portion, wherein the protruding plate portion continues to a peripheral portion of the hinge connecting member and is disposed in the upper plate member.

2. The mobile terminal apparatus according to claim 1, wherein the protruding plate portion is partly bent.

3. A mobile terminal apparatus including a movable housing and a stationary housing which are connected in a foldable manner by a hinge connecting member comprising:
a movable rear casing disposed in the movable housing, the movable rear casing including a front panel and an upper plate member, the upper plate member secured to the front panel; and
a piece of plate member disposed within the upper plate member for reinforcing the upper plate member, wherein the piece of plate portion continues to a peripheral portion of the hinge connecting member.
